(19) United States
(12) Patent Application Publication
(10) Pub. No.: US 2013/0110478 A1
(43) Pub. Date: May 2, 2013

(54) APPARATUS AND METHOD FOR BLIND BLOCK RECURSIVE ESTIMATION IN ADAPTIVE NETWORKS

(71) Applicants: MUHAMMAD OMER BIN SAEED, DHAHRAN (SA); AZZEDINE ZERGUINE, DHAHRAN (SA); SALAM A. ZUMMO, DHAHRAN (SA)

(72) Inventors: MUHAMMAD OMER BIN SAEED, DHAHRAN (SA); AZZEDINE ZERGUINE, DHAHRAN (SA); SALAM A. ZUMMO, DHAHRAN (SA)

(73) Assignee: KING FAHD UNIVERSITY OF PETROLEUM AND MINERALS, DHAHRAN (SA)

(21) Appl. No.: 13/286,151

(22) Filed: Oct. 31, 2011

(51) Int. Cl. G06F 17/10

(52) U.S. Cl. 703/2

(57) ABSTRACT

The apparatus and method for blind block recursive estimation in adaptive networks, such as a wireless sensor networks, uses recursive algorithms based on Cholesky factorization (Cholesky) or singular value decomposition (SVD). The algorithms are used to estimate an unknown vector of interest (such as temperature, sound, pressure, motion, pollution, etc.) using cooperation between neighboring sensor nodes in the wireless sensor network. The method incorporates the Cholesky and SVD algorithms into the wireless sensor networks by creating new recursive diffusion-based algorithms, specifically Diffusion Blind Block Recursive Cholesky (DBBRC) and Diffusion Blind Block Recursive SVD (DBBRS). Both DBBRC and DBBRS perform much better than the no cooperation case where the individual sensor nodes do not cooperate. A choice of DBBRC or DBBRS represents a tradeoff between computational complexity and performance.

### BACKGROUND OF THE INVENTION

1. Field of the Invention

The present invention relates generally to wireless sensor networks, and particularly an apparatus and method for blind block recursive estimation in adaptive networks that provides the sensors with parameter estimation capability in the absence of input regressor data.

2. Description of the Related Art

A wireless sensor network is an adaptive network that employs distributed autonomous devices having sensors to cooperatively monitor physical and/or environmental conditions, such as temperature, sound, vibration, pressure, motion, pollutants, etc., at different locations. Wireless sensor networks are used in many different application areas, including environmental, habitat, healthcare, shipping, traffic control, etc.

Wireless sensor networks often include a plurality of wireless sensors spread over a geographic area. The sensors take readings of some specific data, and if they have the capability, perform some signal processing tasks before the data is collected from the sensors for more detailed thorough processing.

In reference to wireless sensor networks, the term “diffusion” is used to identify the type of cooperation between sensor nodes in the wireless sensor network. Data that is to be shared by any sensor is diffused into the wireless sensor network in order to be captured by its respective neighbors that are involved in cooperation.

A “fusion-center based” wireless network has sensors transmitting all the data to a fixed center, where all the processing takes place. An “ad hoc” network is devoid of such a center, and the processing is performed at the sensors themselves, with some cooperation between nearby neighbors of the respective sensor nodes. An ad-hoc network is established spontaneously as sensor nodes connect and the nodes forward data to and from each other.

A mobile ad-hoc network (MANET) is an example of a kind of ad-hoc network. A MANET is a self-configuring network of mobile routers connected by wireless links. The routers are free to move randomly so the network's wireless topology may change rapidly and unpredictably.

Recently, several algorithms have been developed to manage and exploit the ad hoc nature of the sensor nodes, and cooperation schemes have been formalized to improve estimation in sensor networks.

Least mean squares (LMS) algorithms are a class of adaptive filters used to mimic a desired filter by finding the filter coefficients that relate to producing the least mean squares of the error signal, i.e., the difference between the desired and the actual signal. The LMS algorithm is a stochastic gradient descent method, in that the filter is only adapted based on the error at the current time.

FIG. 1 diagrammatically illustrates an adaptive network 100 having N nodes 105. In the following, boldface letters are used to represent vectors and matrices, and non-bolded letters represent scalar quantities. Matrices are represented by capital letters, and lower-case letters are used to represent vectors. The notation (.)^{T} stands for transposition for vectors and matrices, and expectation operations are denoted as E[.]. In FIG. 1 the adaptive network 100 has a predefined topology. For each node k, the number of neighbors is given by Nₖ, including the node k itself, as shown in FIG. 1. At each iteration i, the output of the system at each node is given by:

dₖ(i)=u_{k,i}w⁰+vₖ(i), 1≦k≦N (1)

where u_{k,i} is a 1×M input regressor row vector of length M, vₖ is a spatially uncorrelated zero-mean additive white Gaussian noise with variance σᵥ_{ₖ}², w⁰ is an unknown column vector of length M, and i denotes the time index. The goal is to characterize the unknown column vector w⁰ using the available sensed data dₖ(i). An estimate of the unknown vector can be denoted by an (M×1) vector w_{k,i} . Assuming that each node cooperates only with its neighbors, each node k has access to updates w_{l,i}, from its Nₖ neighbor nodes at every time instant i, where l ∈ Nₖ\k, in addition to its own estimate, w_{k,i}. An adapt-then-combine (ATC) diffusion scheme first updates the local estimate using an adaptive algorithm, and then estimates from the neighbor nodes, which are fused together.

The adaptation can be performed using two different techniques. The first technique is the Incremental Least Mean Squares (ILMS) method, in which each node updates its own estimate at every iteration, and then passes on its estimate to the next node. The estimate of the last node is taken as the final estimate of that iteration. The second technique is the Diffusion LMS (DLMS), where each node combines its own estimate with the estimates of its neighbors using some combination technique, and then the combined estimate is used for updating the node estimate. This method is referred to as Combine-Then-Adapt (CTA) diffusion. It is also possible to first update the estimate using the estimate from the previous iteration, and then combine the updates from all neighboring nodes to form the final estimate for the iteration. This method is known as Adapt-Then-Combine (ATC) diffusion. Simulation results show that ATC diffusion outperforms CTA diffusion.

Using LMS, the ATC diffusion algorithm is given by:

$$\{ \begin{matrix}{f}_{k , i} = {y}_{k , i - 1} + {μ}_{k} {u}_{k , i}^{T} ( {d}_{k} ( i ) - {u}_{k , i} {y}_{k , i - 1} ) \\ {y}_{k , i} = {\sum }_{l ɛ {N}_{k}} {c}_{lk} {f}_{l , i}\end{matrix} \} , \qquad ( 2 )$$

where {cₗₖ}_{l∈N}_{ₖ} is a combination weight for each node k, which is fixed, }f_{l,i}}_{l∈N}_{ₖ} is the local estimate for each node neighboring node k, μₖ is the node step-size and y_{k,i-1} represents an estimate of an output vector for each node k at iteration i−1.

The conventional Diffusion Least Mean Square (LMS) technique uses a fixed step-size, which is chosen as a trade-off between steady-state maladjustment and speed of convergence. A fast convergence, as well as low steady-state maladjustment, cannot be achieved with this technique.

Unfortunately, these algorithms assume that the input regressor data is available to the sensors. However, in real world applications this data is not always available to the sensors. In such cases, blind parameter estimation is desirable. Thus, an apparatus and method for blind block recursive estimation in adaptive networks solving the aforementioned problems is desired.

### SUMMARY OF THE INVENTION

The apparatus and method for blind block recursive estimation in adaptive networks, such as a wireless sensor networks, uses novel recursive algorithms based on Cholesky factorization (Cholesky) or singular value decomposition (SVD). The recursive algorithms are used to estimate an unknown vector of interest (such as temperature, sound, pressure, motion, pollution, etc.) using cooperation between neighboring sensor nodes in the wireless sensor network. As described herein, the present method incorporates the Cholesky and SVD algorithms into the wireless sensor networks by creating new recursive diffusion-based algorithms, specifically Diffusion Blind Block Recursive Cholesky (DBBRC) and Diffusion Blind Block Recursive SVD (DBBRS).

Both DBBRC and DBBRS are shown herein to perform much better than the no cooperation case in which the individual sensor nodes do not cooperate. More specifically, simulation results show that the DBBRS algorithm performs much better than the no cooperation case, but is also computationally very complex. Comparatively, the DBBRC algorithm is computationally less complex than the DBBRS algorithm, but does not perform as well. A choice between DBBRC and DBBRS represents a tradeoff between computational complexity and performance. A detailed comparison of the two algorithms is provided below.

In a preferred embodiment, using DBBRS, a blind block recursive method for estimation of a parameter of interest in an adaptive network is given by the following steps: (a) establishing an adaptive network having a plurality of N nodes, N being an integer greater than one, each node connected directly to at least one neighboring node, with all the neighboring connected nodes sharing their estimates with each other; (b) establishing a time integer i to represent an increment of time; (c) forming an auto-correlation matrix for iteration i from the equation \hat{R}_{d}(i)=\hat{R}_{d}(i−1)+dᵢdᵢ^{T} to derive the equation \hat{R}_{d,k}(i)=d_{k,i}d_{k,i}^{T}+\hat{R}_{d,k}(i−1) for each node k; (d) obtaining Uₖ(i) from a singular value decomposition (SVD) of \hat{R}_{d,k}(i); (e) forming Ũₖ(i) from null eigenvectors of Uₖ(i); (f) forming Hankel matrices of size (L×M−1) from individual vectors of Ũₖ (i); (g) forming Uₖ(i) by concatenating the Hankel matrices; (h) identifying a selected null eigenvector from the SVD of Uₖ(i) as an estimate of \tilde{w}_{k,i}; (i) deriving an intermediate update ĥ_{k,i} using \tilde{w}_{k,i} in the equation \tilde{w}ᵢ=λ\tilde{w}ᵢ₋₁+(1−λ)\tilde{w}ᵢ to form the equation ĥ_{k,i}=λŵ_{k,i-1}+(1−λ)\tilde{w}_{k,i}; (j) combining estimates from connected neighboring nodes of node k to produce ŵ_{k,i} according to the equation

$${\hat{w}}_{k , i} = {\sum }_{l ɛ {N}_{k}} {c}_{lk} {\hat{h}}_{l , i} ;$$

(k) storing ŵ_{k,i} in computer readable memory; and (l) calculating an output of the adaptive network at each node k with ŵ_{k,i}.

In another preferred embodiment, using DBBRC, a blind block recursive method for estimation of a parameter of interest in an adaptive network is given by the following steps: (a) establishing an adaptive network having a plurality of N nodes, N being an integer greater than one, each node connected directly to at least one neighboring node, with all the neighboring connected nodes sharing their estimates with each other; (b) establishing a time integer i to represent an increment of time; (c) defining a forgetting factor as

$${λ}_{k , i} = 1 - \frac{1}{i} ;$$

(d) forming an auto-correlation matrix for iteration i from this equation \hat{R}_{d}(i)=\hat{R}_{d}(i−1)+dᵢdᵢ^{T} to derive this equation \hat{R}_{w,k}(i)=(1−λ_{k,i})(d_{k,i}d_{k,i}^{T}−\hat{σ}_{v,k}²I_{K})+λ_{k,i}\hat{R}_{w,k}(i−1) for each node k; (e) obtaining the Cholesky factor of \hat{R}_{w,k}(i) and applying a vector operator to derive ĝ_{k,i};(f) deriving an intermediate update ĥ_{k,i} using \tilde{w}_{k,i}, as given by this equation ĥ_{k,i}=Q_{A}(ĝ_{k,i}−λ_{k,i}ĝ_{k,i-1})+λ_{k,i}ŵ_{k,i-1}; combining estimates from connected neighboring nodes of node k to produce ŵ_{k,i} according to the equation

$${\hat{w}}_{k , i} = {\sum }_{l ɛ {N}_{k}} {c}_{lk} {\hat{h}}_{l , i} ;$$

(k) storing ŵ_{k,i} in computer readable memory; (k) storing ŵ_{k,i} in computer readable memory; and (l) calculating an output of the adaptive network at each node k with ŵ_{k,i}.

These and other features of the present invention will become readily apparent upon further review of the following specification.

### BRIEF DESCRIPTION OF THE DRAWINGS

FIG. 1 is a diagram showing an exemplary adaptive network having N nodes.

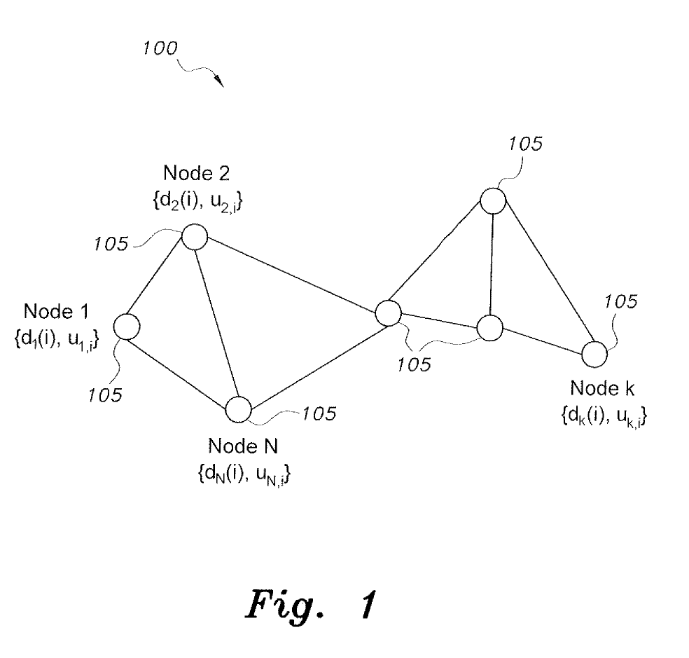

FIG. 2 is a graph showing results of a simulation comparing an embodiment of a method for blind block recursive estimation in adaptive networks according to the present invention that is based on recursive Cholesky factorization against an embodiment based on recursive singular value decomposition (SVD) at a signal-to-noise ratio (SNR) of 10 dB.

FIG. 3 is a graph showing results of a simulation comparing an embodiment of a method for blind block recursive estimation in adaptive networks according to the present invention that is based on recursive Cholesky factorization against an embodiment based on recursive singular value decomposition (SVD) at a signal-to-noise ratio (SNR) of 20 dB.

FIG. 4 is a block diagram of a computer system for implementing the apparatus and method for blind block recursive estimation in adaptive networks according to the present invention.

Similar reference characters denote corresponding features consistently throughout the attached drawings.

### DETAILED DESCRIPTION OF THE PREFERRED EMBODIMENTS

The apparatus and method for blind block recursive estimation in adaptive networks, such as a wireless sensor networks, uses novel recursive algorithms developed by the inventors that are based on Cholesky factorization (Cholesky) or singular value decomposition (SVD). This is in contrast to conventional least mean square algorithms used in adaptive filters and the like. An example of a redundant filter bank preceding to construct data blocks that have trailing zeros is shown in “Redundant Filterbank Precoders and Equalizers Part II: Blind Channel Estimation, Synchronization, and Direct Equalization”, IEEE Transactions on Signal Processing, Vol. 47, No. 7, pp. 2007-2022, July 1999, by A. Scaglione, G. B. Giannakis, and S. Barbarossa (known herein as “Filterbank”), which is hereby incorporated by reference in its entirety.

Filterbank uses redundant precoding to construct data blocks that have trailing zeros. These data blocks are then collected at the receiver and used for blind channel identification. In this work, however, there is no precoding required. The trailing zeros will be in the examples for estimation purposes. Let the unknown vector be of size (L×1). If the input vector is a (P×1) vector with P−M trailing zeros, then:

sᵢ={s₀(i), s₁(i), . . . , s_{M-1}(i), 0, . . . , 0}^{T} (3)

where P and M are related through P=M+L−1. The unknown vector can be written in the form of a convolution matrix given by

$$W = [ \begin{matrix}w ( 0 ) & 0 & … & 0 \\ ⋮ & ⋱ & ⋱ & ⋮ \\ w ( L - 1 ) & ⋱ & ⋱ & 0 \\ 0 & ⋱ & ⋱ & w ( 0 ) \\ ⋮ & ⋱ & ⋱ & ⋮ \\ 0 & … & 0 & w ( L - 1 )\end{matrix} ] \qquad ( 4 )$$

where w⁰=[w(0), w(1), . . . , w(L−1)] is the unknown vector. The output data block can now be written as:

dᵢ=Wsᵢ+vᵢ (5)

where vᵢ is added noise and dᵢ is the output vector d at iteration i.

The output blocks are collected together to form a matrix, D_{N}=(d_{0,} d_{0,} . . . , d_{N-1}), where N is greater than the minimum number of data blocks required for the input blocks to have a full rank. The singular value decomposition (SVD) of the auto-correlation of D_{N} gives a set of null eigenvector& These eigenvcctors are then used to form a Hankel matrix and the null space of this matrix gives a unique vector, which is the estimate of the unknown vector w⁰. The final estimate is usually accurate up to a constant multiplicative factor.

An example of a Cholesky factorization-based solution can be found in “A Cholesky Factorization Based Approach for Blind FIR Channel Identification,” IEEE Transactions on Signal Processing, Vol. 56, No. 4, pp. 1730-1735, April 2008, by J. Choi and C. C. Lim (known herein as “Cholesky”), which is hereby incorporated by reference in its entirety. Using the Cholesky factorization-based solution, the output equation is:

dᵢ=Wsᵢ^{T}+vᵢ (6)

Taking the auto-correlation of dᵢ in equation (6), and assuming the input data regressors are white Gaussian noise with a variance of σᵤ², the regressor formula is:

R_{d}=E[dᵢdᵢ^{T}]=σₛ²WW^{T}+σᵥ²I (7)

Where R_{d} is the correlation matrix for block vector dᵢ. Input regressor data is a vector that serves as the input to the system which is being estimated. In blind estimation approaches this data is unknown. If the second order statistics for both the input regressor data and the additive white Gaussian noise are known, then the correlation matrix for the unknown vector can be written as:

R_{w}=WW^{T}=(R_{d}σᵥ²I)/σₛ² (8)

As described in Cholesky, because the correlation matrix is not available at the receiver, and approximate matrix is calculated using K blocks of data. So equation (8) becomes:

$${\hat{R}}_{w} = \frac{1}{K} {\sum }_{i = 1}^{K} {d}_{i} {d}_{i}^{T} - {\hat{σ}}_{v}^{2} {I}_{K} \qquad ( 9 )$$

where \hat{σ}ᵥ² is the estimate of the noise variance and I_{K} is the identity matrix of size K Taking the Cholesky factor of this matrix gives us the upper triangular matrix, which is vectorized to produce:

ĝ=vec{_{chol{\hat{R}}_{W}}} (10)

The vectors g and w⁰ are related through the equation:

g=Qw⁰ (11)

where Q is a M²×M selection matrix given in Cholesky. The least squares solution is then given by:

ŵ=(Q^{T}Q)⁻¹Q^{T}ĝ (12)

where the matrix (Q^{T}Q)⁻¹Q^{T} can be calculated by known methods.

Both the blind block recursive singular value decomposition (SVD) algorithm and a related blind block recursive Cholesky algorithm will now be described in additional detail. These blind block methods require that several blocks of data be stored before estimation can be performed. Although the least squares approximation gives a good estimate, in the present method, the wireless sensor network (WSN) uses a recursive algorithm to enable the nodes to cooperate and enhance overall performance. By making both the SVD and Cholesky algorithms recursive, the present method enables them to be better utilized in a WSN environment.

In the blind block recursive SVD algorithm, the algorithm taught by Filterbank is converted in accordance with the present method into a block recursive algorithm. Since the Filterbank algorithm requires a complete block of data, the present method uses an iterative process on blocks as well. So, instead of the matrix D, we have the block data vector d. The recursive form for the auto-correlation matrix is given by:

\hat{R}_{d}(i)=\hat{R}_{d}(i−1)+dᵢdᵢ^{T} (13)

The next step is to derive the eigendecomposition for this matrix. Applying the SVD on R_{d} yields the eigenveetor matrix U, which is used to derive (L−1×M) matrix Ũ that folios the null space of the autocorrelation matrix, which is used to form Hankel matrices of size (L×M+1). The Hankel matrices that are concatenated to yield the matrix U(i), from which the estimate for \tilde{w}(i) is derived as such:

SVD{R_{d}(i)} [symbol] U(i) [symbol] Ũ(i) [symbol] U(i) [symbol] \tilde{w}ᵢ (14)

The recursive update for this estimate of the unknown vector is then given by:

\tilde{w}ᵢ=λ\tilde{w}ᵢ₋₁+(1−λ)\tilde{w}ᵢ (15)

It can now be seen that the recursive SVD algorithm does not become computationally less complex. However, the recursive SVD algorithm requires much less memory, and the result improves with an increase in the number of data blocks.

In the blind block recursive Cholesky algorithm, the algorithm taught by Cholesky is converted in accordance with the present invention into a blind block recursive algorithm. Equation (9) is rewritten as:

$${\hat{R}}_{w} ( i ) = \frac{1}{i} ( {d}_{i} {d}_{i}^{T} - {\hat{σ}}^{2} {I}_{K} ) + \frac{i - 1}{i} {\hat{R}}_{w} ( i - 1 ) \qquad ( 16 )$$

Equation (10) can now be expressed as:

ĝᵢ=vec{chol{\hat{R}_{w}(i)}} (17)

By using Q_{A}=(Q^{T}Q)⁻¹Q^{T} yields ŵᵢ=Q_{A}ĝᵢ. Further, combining equation (16) into equation (17), the recursive solution becomes:

$${\hat{g}}_{i} = vec \{ chol \{ \frac{1}{i} ( {d}_{i} {d}_{i}^{T} - {\hat{σ}}^{2} {I}_{K} ) + \frac{i - 1}{i} {\hat{R}}_{w} ( i - 1 ) \} \} \qquad ( 18 )$$

Recognizing that

$$choli \{ \frac{i - 1}{i} {\hat{R}}_{w} ( i - 1 ) \} = \frac{i - 1}{i} \hat{g} ( i - 1 )$$

and solving the equations, the final recursive Cholesky solution is:

$${\hat{w}}_{i} = {Q}_{A} \{ {\hat{g}}_{i} - \frac{i - 1}{i} {\hat{g}}_{i - 1} \} + \frac{i - 1}{i} {\hat{w}}_{i - 1} \qquad ( 19 )$$

To incorporate the above-defined recursive SVD and recursive Cholesky algorithms into a WSN, the ATC scheme is used for diffusion and incorporates the recursive algorithms directly to derive a Diffusion Blind Block Recursive SVD (DBBRS) algorithm and Diffusion Blind Block Recursive Cholesky (DBBRC) algorithm, respectively. Reforming the algorithms from the previous section, the new algorithms can be summarized as shown in Tables 1 and 2. The subscript k denotes the node number, N^{k} is the set of neighbors of node k, ĥₖ is the intermediate estimate for node k, cₗₖ is the combination weight for the estimate coming from node l to node k, Uₖ is the eigenvector matrix for node k, and w_{k,i} is the estimate of unknown vector parameter W at iteration i for node k.

TABLE 1
Diffusion Blind Block Recursive SVD (DBBRS) Algorithm

| | |
|---|---|
| Step 1. | Form auto-correlation matrix for iteration i from equation (13) for |
| | each node k. |
| | \hat{R}_{d,k}(i) = d_{k,i}d_{k,i}^{T} + \hat{R}_{d,k}(i − 1) |
| Step 2. | Obtain Uₖ(i) from SVD of \hat{R}_{d,k}(i). |
| Step 3. | Form Ũₖ(i) from the null eigenvectors of Uₖ(i). |
| Step 4. | Form Hankel matrices of size (L × M − 1) from individual vectors |
| | of Ũₖ(i). |
| Step 5. | Form Uₖ(i) by concatenating the Hankel matrices. |
| Step 6. | Identify the null eigenvector from the SVD of Uₖ(i) as the estimate |
| | of \tilde{w}_{k,i}. |
| Step 7. | Use \tilde{w}_{k,i} in equation (15) to derive the intermediate update ĥ_{k,i}. |
| | ĥ_{k,i} = λŵ_{k,i-1} + (1 − λ)ŵ_{k,i} |
| Step 8. | Combine estimates from neighbors of node k to produce ŵ_{k,i}. |
| | ${\hat{w}}_{k , i} = {Σ}_{l ɛ {N}_{k}} {c}_{lk} {\hat{h}}_{l , i}$ |

Diffusion Blind Block Recursive Cholesky (DBBRC) Algorithm

| | |
|---|---|
| Step 1. | $Let a forgetting factor be defined as {λ}_{k , i} = 1 - \frac{1}{i} .$ |
| Step 2. | Form auto-correlation matrix for iteration i from the following |
| | equation for each node k. |
| | \hat{R}_{w,k}(i) = (1 − λ_{k,i})(d_{k,i}d_{k,i}^{T} − \hat{σ}_{v,k}²I_{K}) + λ_{k,i}\hat{R}_{w,k}(i − 1) |
| Step 3. | Obtain the Cholesky factor of \hat{R}_{w,k}(i) and apply the vector operator |
| | to derive ĝ_{k,i}. |
| Step 4. | Obtain the intermediate update as given by |
| | ĥ_{k,i} = Q_{A}(ĝ_{k,i} − λ_{k,i}ĝ_{k,i-1}) + λ_{k,i}ŵ_{k,i-1}. |
| Step 5. | The final update is the weighted sum of the estimates of all |
| | neighbors of node k. |
| | ${\hat{w}}_{k , i} = {Σ}_{l ɛ {N}_{k}} {c}_{lk} {\hat{h}}_{l , i}$ |

To better understand the differences in performance of the DBBRS and DBBRC algorithms, it is useful to look at computational complexity, as it illustrates how much an algorithm gains in terms of decreased computations as it loses in terms of performance. Conversely, one can examine the computation cost associated with a gain in performance. Both the non-recursive and recursive algorithms are reviewed below.

In the SVD-based algorithm, the length of the unknown vector is M and the data block size is K. A total number of N data blocks are required for estimation, where N≧K. This means that a data block matrix is of size K×N. The total number of computations required for the whole algorithm is given by Equation 20:

$${T}_{C , SVD} = \frac{4}{3} {K}^{3} + ( 2 N + \frac{1}{2} ) {K}^{2} + \frac{19}{6} K + ( 2 K + \frac{7}{3} ) {M}^{3} - 2 {M}^{4} + ( 1 - 4 K ) \frac{{M}^{2}}{2} + \frac{19}{6} M - 12 \qquad ( 20 )$$

Similar to the SVD algorithm, in the Cholesky factorization-based algorithm, the length of the unknown vector is M and the data block size is K. A total number of N data blocks are required for estimation where N≧K. The SVD process is replaced by Cholesky factorization. The total number of computations required is reduced, as given by Equation 21:

T_{C,Chol}=4/3K³+(2N+1/2)K²+19/6K−4+1/3(7M³+3M²−M) (21)

Turning to the recursive SVD-based algorithm, the change in the overall algorithm is modest, but has the significant effect of reducing the calculations by nearly one-half, The computations are now given by Equation 22:

$${T}_{C , RS} = \frac{4}{3} {K}^{3} + \frac{7}{2} {K}^{2} + \frac{19}{6} K + ( 2 K + \frac{7}{3} ) {M}^{3} - 2 {M}^{4} + ( 1 - 4 K ) \frac{{M}^{2}}{2} + \frac{25}{6} M - 10 \qquad ( 22 )$$

Similar to the recursive SVD-Based Algorithm, the number of computations for the Recursive Cholesky Factorization-Based Algorithm is reduced as well, and the total number of computations are now given by:

T_{C,RC}=4/3K³+7/2K²+19/6K+1/3(7M³+3M²+2M) (23)

However, it should be noted that the estimation of the noise variance need not be repeated at each iteration. More specifically, after a few iterations, the number of which can be fixed beforehand, the noise variance can be estimated, and then this same value can be used in the remaining iterations instead of estimating it repeatedly. Then number of calculation thus reduces to:

T_{C,RC}=2K²+1/3(7M³+3M²+2M)+4 (24)

All of the algorithms may be compared in specific reference scenarios. In one example, the value for M is 4 and for N is 20. The value for K is correspondingly varied, whereas the value of N is varied between 10 and 20 for the least squares algorithms. The number of calculations for the recursive algorithms is shown for one iteration only. The last algorithm is the Cholesky Recursive Based Algorithm (RLS) where the noise variance is calculated only once, after a select number of iterations have occurred, and then is kept constant. The tables below summarize the results:

TABLE 2
Number of Computations for the Non-Recursive
Least Squares Algorithms

| | K = 10 | K = 20 |
|---|---|---|
| SVD | 6,021 | 28,496 |
| Cholesky | 5,575 | 27,090 |

TABLE 3
Number of Computations for the Recursive Algorithms

| | K = 10 | K = 20 |
|---|---|---|
| RSVD | 2,327 | 13,702 |
| RCF | 1,883 | 12,298 |
| RCFNV | 372 | 972 |

Table 3 shows the number of computations for the non-recursive (original) algorithms, showing that the Cholesky-based method requires less computations than SVD, and the tradeoff between performance and complexity is illustrated and justified, i.e., greater performance comes at a cost of a greater number of computations, the desirability of which depends on the environment the algorithm is deployed in and the precision required.

Table 4 shows the number of computations per iteration for the recursive algorithms. RSVD gives the number of computations for the recursive SVD-based algorithm, and RCF is for the recursive Cholesky-based algorithm. RCFNV lists the number of computations for the recursive Cholesky based algorithm when the noise variance is estimated only once. This shows how the complexity of the algorithm can be reduced greatly by a careful improvements. Although the performance does suffer slightly, the gain in complexity more than compensates for this loss.

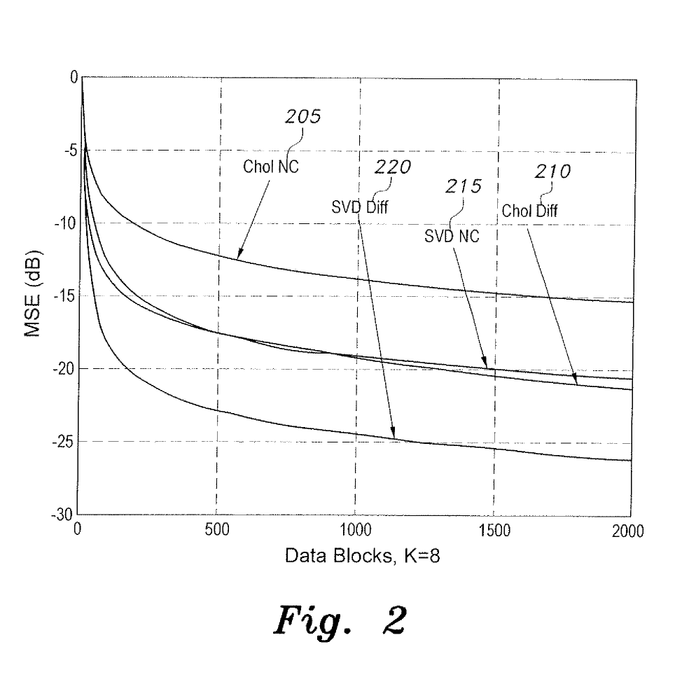

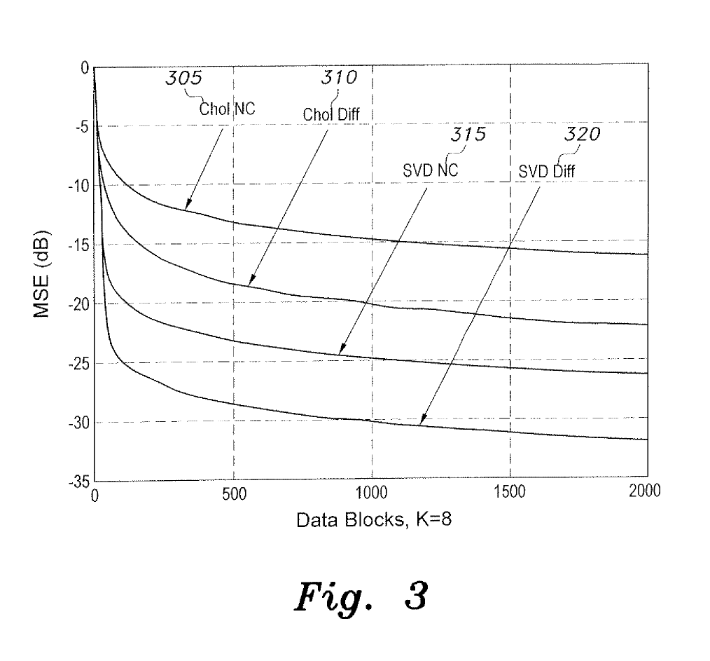

We now compare results for the recursive algorithms (recursive SVD and recursive Cholesky) in accordance with the present method. Results are shown in FIG. 2 and FIG. 3 for an exemplary WSN of 20 nodes. The forgetting factor is varied for the DBBRC algorithm and kept fixed at λ={0.9} for the DBBRS algorithm, as the algorithms show best performance this way. The two algorithms are used to identify an unknown vector of length M=4 in an environment with signal-to-noise ratio (SNR) taken as 10 dB in FIG. 2, and 20 dB in FIG. 3. The block size is taken as K=8. Results are shown in FIG. 2 and FIG. 3 for the two algorithms for both diffusion (Diff) and no cooperation (NC) cases.

Referring to FIG. 2, there is shown a graph comparing mean square error (MSE) versus the number of data blocks where K=8 and the SNR is 10 dB, as described above. The Chol(esky) NC curve 205, Chol(esky) Diff curve 210, SVD NC curve 215, and SVD Diff curve 220 are shown together for comparison purposes. As can be seen in FIG. 2, for both Cholesky and SVD algorithms, diffusion outperforms no cooperation between nodes in the simulated WSN.

Referring to FIG. 3, there is shown a graph comparing mean square error (MSE) versus the number of data blocks where K=8 and the SNR is 20 dB, as described above. The Chol(esky) NC curve 305, Chol(esky) Diff curve 310, SVD NC curve 315 and SVD Diff curve 320 are shown together for comparison purposes. Similar to FIG. 2, it can be seen in FIG. 3 for both Cholesky and SVD algorithms, that diffusion outperforms no cooperation between nodes in the simulated WSN.

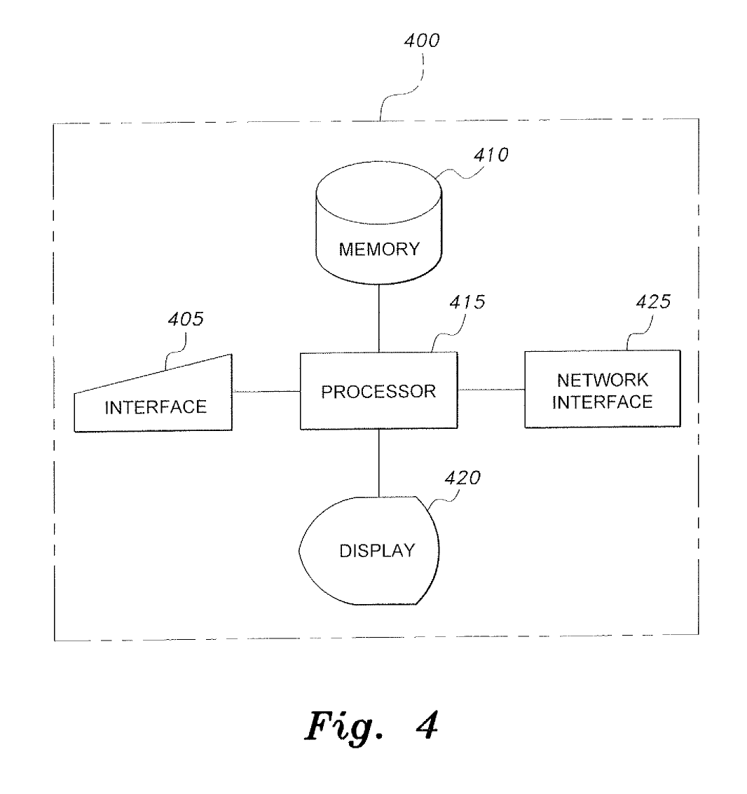

Referring to FIG. 4 there is shown a generalized system 400 for implementing the blind block recursive apparatus and method for estimation in adaptive networks, although it should be understood that the generalized system 400 may represent a stand-alone computer, a computer terminal, a portable computing device, a networked computer or computer terminal, or a networked portable device. Data may be entered into the system 400 by a user via any suitable type of user interface 405, including a keyboard, voice recognition system, etc., and may be stored in computer readable memory 410, which may be any suitable type of computer readable and programmable memory. Calculations are performed by the processor 415, which may be any suitable type of computer processor, and may be displayed to the user on the display 420, which may be any suitable type of computer display. The system 400 preferably includes a network interface 425, such as a modem or the like, allowing the computer system 400 to be networked, such as with a local area network, wide area network or the Internet.

The processor 415 may be associated with, or incorporated into, any suitable type of computing device, for example, a personal computer or a programmable logic controller. The display 420, the processor 415, the memory 410, the user interface 405, network interface 425 and any associated computer readable media are in communication with one another by any suitable type of data bus, as is well known in the art. Additionally, other standard components, such as a printer or the like, may interface with system 400 via any suitable type of interface.

Examples of computer readable media include a magnetic recording apparatus, an optical disk, a magneto-optical disk, and/or a semiconductor memory (for example, RAM, ROM, etc.). Examples of magnetic recording apparatus that may be used in addition to memory 410, or in place of memory 410, include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

Thus, there has been described in detail blind block recursive algorithms based on Cholesky factorization and singular value decomposition (SVD) with diffusion. The algorithms are used to estimate an unknown vector of interest in a wireless sensor network (WSN) using cooperation between neighboring sensor nodes. Incorporating the algorithms into the sensor networks creates new diffusion-based algorithms, which are shown to perform much better than their corresponding no cooperation cases. The two algorithms are named Diffusion Blind Block Recursive Cholesky (DBBRC) and Diffusion Blind Block Recursive SVD (DBBRS) algorithms. Simulation results show that the DBBRS algorithm performs much better, but is also computationally very complex. Comparatively, the DBBRC algorithm is computationally less complex, but does not perform as well as DBBRS, although it is still far more desirable than the no cooperation cases. In practical applications, Digital Signal Processors (DSPs) configured to execute the algorithms may be incorporated into the sensor nodes to perform the calculations described herein.

The apparatus and method described herein is well suited to a variety of practical applications in which the estimated parameter is used directly, e.g., military applications (such as radar) and environmental applications (such as the monitoring of ecological systems), etc.

It is to be understood that the present invention is not limited to the embodiments described above, but encompasses any and all embodiments within the scope of the following claims.

We claim:

1. A blind block recursive method for estimation of a parameter of interest in an adaptive network, comprising the steps of;
(a) establishing an adaptive network having a plurality of N nodes, N being an integer greater than one, each of the nodes being connected directly to at least one neighboring node, all of the neighboring connected nodes sharing their estimates with each other;
(b) establishing a time integer i to represent an increment of time;
(c) forming an auto-correlation matrix for iteration i from \hat{R}_{d}(i)=\hat{R}_{d}(i−1)+dᵢdᵢ^{T} to derive \hat{R}_{d,k}(i)=d_{k,i}d_{k,i}^{T}+\hat{R}_{d,k}(i−1) for each node k;
(d) obtaining Uₖ(i) from a singular value decomposition (SVD) of \hat{R}_{d,k}(i);
(e) forming Ũₖ(i) from null eigenvectors of Uₖ(i);
(f) forming Hankel matrices of size (L×M−1) from individual vectors of Ũₖ(i);
(g) forming Uₖ(i) by concatenating the Hankel matrices;
(h) identifying a selected null eigenvector from an SVD of Uₖ(i) as an estimate of \tilde{w}_{k,i};
(i) deriving an intermediate update ĥ_{k,i} using \tilde{w}_{k,i} in \tilde{w}ᵢ=λ\tilde{w}ᵢ₋₁+(1−λ)\tilde{w}ᵢ to form ĥ_{k,i}=λŵ_{k,i-1}+(1−λ)\tilde{w}_{k,i};
(j) combining estimates from at least one neighbor of node k to produce ŵ_{k,i} according to
$${\hat{w}}_{k , i} = {\sum }_{l ɛ {N}_{k}} {c}_{lk} {\hat{h}}_{l , i} ;$$
(j) combining estimates from connected neighboring nodes of node k to produce ŵ_{k,i} according to the equation
$${\hat{w}}_{k , i} = {\sum }_{l ɛ {N}_{k}} {c}_{lk} {\hat{h}}_{l , i} ;$$
(k) storing ŵ_{k,i} in computer readable memory; and
(l) calculating an output of the adaptive network at each node k with ŵ_{k,i}.

2. The blind block recursive method of claim 1, further comprising the step of calculating a Least Mean Squares (LMS) estimate using an Adapt-Then-Combine diffusion algorithm given by:
$$\{ \begin{matrix}{f}_{k , i} = {y}_{k , i - 1} + {μ}_{k} {u}_{k , i}^{T} ( {d}_{k} ( i ) - {u}_{k , i} {y}_{k , i - 1} ) \\ {y}_{k , i} = {\sum }_{l ɛ {N}_{k}} {c}_{lk} {f}_{l , i}\end{matrix} \} ,$$
where is {cₗₖ}_{l∈N}_{ₖ} is a combination weight for each node k, {f_{l,i}}_{l∈N}_{ₖ} is the local estimate for each node neighboring node k, μₖ is the node step-size, and y_{k,i-1} represents an estimate of an output vector for each node k at iteration i−1.

3. The blind block recursive method of claim 2, wherein the adaptive network is a wireless signal network.

4. The blind block recursive method of claim 3, wherein the wireless signal network contains at least twenty (20) sensor nodes.

5. The blind block recursive method of claim 4, wherein the parameter of interest is a measurement of temperature.

6. The blind block recursive method of claim 4, wherein the parameter of interest is a measurement of sound.

7. The blind block recursive method of claim 4, wherein the parameter of interest is a measurement of pressure.

8. The blind block recursive method of claim 4, wherein the parameter of interest is a measurement of motion.

9. The blind block recursive method of claim 4, wherein the parameter of interest is a measurement of pollution.

10. A blind block recursive method for estimation of a parameter of interest in an adaptive network, comprising the steps of:
(a) establishing an adaptive network having a plurality of N nodes, N being an integer greater than one, each of the nodes being connected directly to at least one neighboring node, all the neighboring connected nodes sharing their estimates with each other;
(b) establishing a time integer i to represent an increment of time;
(c) defining a forgetting factor as
$${λ}_{k , i} = 1 - \frac{1}{i} ;$$
(d) forming an auto-correlation matrix for iteration i from \hat{R}_{d}(i)=\hat{R}_{d}(i−1)+dᵢdᵢ^{T} to derive:
\hat{R}_{w,k}(i)=(1−λ_{k,i})(d_{k,i}d_{k,i}^{T}−\hat{σ}_{v,k}²I_{K})+λ_{k,i}\hat{R}_{w,k}(i−1)
for each node k;
(e) obtaining the Cholesky factor of \hat{R}_{w,k}(i) and applying a vector operator to derive ĝ_{k,i};
(f) deriving an intermediate update ĥ_{k,i} using \tilde{w}_{k,i} as given by:
ĥ_{k,i}=Q_{A}(ĝ_{k,i}−λ_{k,i}ĝ_{k,i-1})+λ_{k,i}ŵ_{k,i-1};
(j) combining estimates from connected neighboring nodes of node k to produce ŵ_{k,i} according to the equation
$${\hat{w}}_{k , i} = {\sum }_{l ɛ {N}_{k}} {c}_{lk} {\hat{h}}_{l , i} ;$$
(k) storing ŵ_{k,i} in computer readable memory; and
calculating an output of the adaptive network at each node k with ŵ_{k,i}.

11. The blind block recursive method of claim 10, further comprising the step of calculating a Least Mean Squares (LMS) estimate using an Adapt-Then-Combine diffusion algorithm given by:
$$\{ \begin{matrix}{f}_{k , i} = {y}_{k , i - 1} + {μ}_{k} {u}_{k , i}^{T} ( {d}_{k} ( i ) - {u}_{k , i} {y}_{k , i - 1} ) \\ {y}_{k , i} = {\sum }_{l ɛ {N}_{k}} {c}_{lk } {f}_{l , i}\end{matrix} \} ,$$
where {cₗₖ}_{l∈N}_{ₖ} is a combination weight for each node k, {f_{l,i}}_{l∈N}_{ₖ} is the local estimate for each node neighboring node k, μₖ is the node step-size, and y_{k,i-1} represents an estimate of an output vector for each node k at iteration i−1

12. The blind block recursive method of claim 11, wherein the adaptive network is a wireless signal network.

13. The blind block recursive method of claim 12, wherein the wireless signal network contains at least twenty (20) sensor nodes.

14. The blind block recursive method of claim 13, wherein the parameter of interest is a measurement of temperature.

15. The blind block recursive method of claim 13, wherein the parameter of interest is a measurement of sound.

16. The blind block recursive method of claim 13, wherein the parameter of interest is a measurement of pressure.

17. The blind block recursive method of claim 13, wherein the parameter of interest is a measurement of motion.

18. The blind block recursive method of claim 13, wherein the parameter of interest is a measurement of pollution.
